(19) United States
(12) Patent Application Publication
(10) Pub. No.: US 2019/0312659 A1
(43) Pub. Date: Oct. 10, 2019

(54) BASE STATION DEVICE, TERMINAL DEVICE, AND TRANSMISSION METHOD

(71) Applicant: FUJITSU LIMITED, Kawasaki-shi (JP)

(72) Inventors: Hongyang CHEN, Kawasaki (JP); Tsuyoshi Shimomura, Yokohama (JP); Jianming Wu, Kawasaki (JP)

(73) Assignee: FUJITSU LIMITED, Kawasaki-shi (JP)

(21) Appl. No.: 16/444,675

(22) Filed: Jun. 18, 2019

Related U.S. Application Data
(63) Continuation of application No. PCT/JP2017/000142, filed on Jan. 5, 2017.

(51) Int. Cl. H04J 13/00; H04W 72/04; H04J 11/00

(52) U.S. Cl. CPC H04J 13/004; H04W 72/0466; H04J 2011/0006; H04W 72/0453; H04J 2011/0009; H04J 11/00

(57) ABSTRACT

A base station device includes: a processor that executes a process including generating first data, generating an indication signal including a plurality of bits that indicate whether second data that is transmitted at a lower latency than the first data is generated, and generating a transmission signal by mapping the generated indication signal and one of the first data and the second data to each of predetermined unit areas of a resource; and a transmitter configured to transmit the transmission signal generated by the processor.

### CROSS-REFERENCE TO RELATED APPLICATION

This application is a continuation of International Application No. PCT/JP2017/000142, filed on Jan. 5, 2017, the entire contents of which are incorporated herein by reference.

### FIELD

The embodiments discussed herein are related to a base station device, a terminal device, and a transmission method.

### BACKGROUND

In current networks, traffic of mobile terminals (smartphones and feature phones) accounts for most of network resources. In addition, traffic used by the mobile terminals tends to increase continuously.

Meanwhile, with the development of Internet of Things (IoT) services (for example, transportation systems, smart meters, monitoring systems for devices and the like), there is a demand to cope with services that have various requirements. Therefore, in the fifth generation mobile communication (5G) standard, technologies that realize a higher data rate, a larger capacity, and a lower latency are desired, in addition to the technologies of the fourth generation mobile communication (4G).

As described above, to cope with a wide variety of services, in 5G, a large number of use cases that are classified into enhanced mobile broadband (eMBB), massive machine type communications (MTC), and ultra-reliable and low latency communication (URLLC) are supposed to be supported.

Among them, URLLC is a use case that is most difficult to be realized. First, there is a requirement for ultra-high reliability such that a target over-the-air block error rate is 10⁻⁵. As one method of realizing the ultra-high reliability, there is a method of increasing the amount of to-be-used resources and ensuring data redundancy. However, the wireless resources are limited, and it is impossible to increase the to-be-used resources without any limitation.

As for a low-latency, there is a requirement in URLLC such that a target over-the-air uplink and downlink user plane latency is 0.5 milliseconds. This is a high requirement to achieve one-tenth or lower than that of the 4G long term evolution (LTE) wireless system.

In URLLC, it is necessary to simultaneously meet the two requirements of ultra-high reliability and low-latency as described above. Further, in 5G, there is a requirement to simultaneously support ultra-reliable and low latency communication data (URLLC data) and other kinds of data (for example, eMBB data and the like) using the same carrier, and it is desirable not to reduce a frequency use efficiency to achieve the requirement.
Non Patent Document 1: “New SID Proposal: Study on New Radio Access Technology”, NTT docomo, RP-160671, 3GPP TSG RAN Meeting #71, Goteborg, Sweden, Mar. 7 to 10, 2016
Non Patent Document 2: 3GPP TR 38.913 V0.3.0 (2016-03)

When eMBB data and URLLC data are multiplexed in the same frequency band, there is a problem in that the efficiency of using time or/and frequency resources is reduced. Specifically, URLLC data is data that is not transmitted continuously, but is transmitted intermittently. Therefore, if resources are allocated to URLLC data in advance, the resource are wasted when URLLC data to be transmitted is absent.

### SUMMARY

According to an aspect of an embodiment, a base station device includes: a processor that executes a process including generating first data, generating an indication signal including a plurality of bits that indicate whether second data that is transmitted at a lower latency than the first data is generated, and generating a transmission signal by mapping the generated indication signal and one of the first data and the second data to each of predetermined unit areas of a resource; and a transmitter configured to transmit the transmission signal generated by the processor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a wireless communication system according to a first embodiment;

FIG. 2 is a block diagram illustrating a configuration of a base station device according to the first embodiment;

FIG. 3 is a diagram illustrating a specific example of resource allocation according to the first embodiment;

FIG. 4 is a flowchart illustrating a transmission process according to the first embodiment;

FIG. 5 is a block diagram illustrating a configuration of a user terminal device according to the first embodiment;

FIG. 6 is a flowchart illustrating a reception process according to the first embodiment;

FIG. 7 is a block diagram illustrating a configuration of the user terminal device according to the first embodiment;

FIG. 8 is a flowchart illustrating another reception process according to the first embodiment;

FIG. 9 is a diagram illustrating a specific example of resource allocation according to a second embodiment;

FIG. 10 is a block diagram illustrating a configuration of a base station device according to a third embodiment;

FIG. 11 is a diagram illustrating a specific example of resource allocation according to the third embodiment;

FIG. 12 is a block diagram illustrating a configuration of a base station device according to a fourth embodiment;

FIG. 13 is a diagram illustrating a specific example of resource allocation according to the fourth embodiment;

FIG. 14 is a diagram for explaining frequency-hopping of an indication signal;

FIG. 15 is a diagram illustrating a specific example of an OFDM symbol; and

FIG. 16 is a diagram for explaining diffuse arrangement of the indication signal.

### DESCRIPTION OF EMBODIMENTS

Preferred embodiments of the present invention will be explained with reference to accompanying drawings. The disclosed technology is not limited by the embodiments below.

### [a] First Embodiment

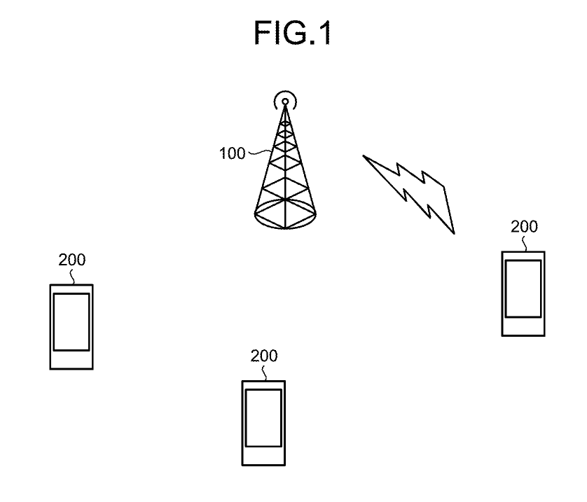

FIG. 1 is a diagram illustrating a configuration of a wireless communication system according to a first embodiment. The wireless communication system illustrated in FIG. 1 includes a base station device 100 and a plurality of user terminal devices 200.

The base station device 100 transmits signals including, for example, eMBB data and URLLC data to the user terminal devices 200. In other words, the base station device 100 allocates resources constituted of time and frequency to the eMBB data and the URLLC data that are addressed to each of the user terminal devices 200 and then generates a transmission signal.

In this case, the base station device 100 provides an area (hereinafter, referred to as a “URLLC area”) that is temporarily reserved as an area in which URLLC data is to be arranged within a resource area that is allocated to eMBB data, and when URLLC data to be transmitted is present, allocates a resource of the URLLC area to the subject URLLC data. The URLLC area may be provided in units of mini slots that are obtained by dividing a slot, for example. With this configuration, it is possible to start transmission of URLLC data for each of the mini slots that are time units shorter than a slot. Then, the base station device 100 arranges, in the URLLC area, an indication signal indicating whether the resource of the URLLC area has been allocated to the URLLC data.

Therefore, if the URLLC data that is to be transmitted is present, the resource of the URLLC area is allocated to the URLLC data and a notice of this allocation is given by the indication signal. Further, if the URLLC data that is to be transmitted is absent, the resource of the URLLC area is allocated to the eMBB data and a notice indicating that the URLLC data is not transmitted is given by the indication signal.

Each of the user terminal devices 200 receives a signal including eMBB data and URLLC data that are transmitted from the base station device 100. Specifically, the user terminal devices 200 are classified into devices that use services related to eMBB, devices that use services related to URLLC, and devices that use services related to both of eMBB and URLLC. Each of the user terminal devices 200 that uses the services related to eMBB identifies eMBB data addressed to the own device and demodulates the eMBB data, on the basis of a control signal and an indication signal included in a reception signal.

Further, each of the user terminal devices 200 that uses the services related to URLLC determines whether URLLC data is included in the reception signal on the basis of the indication signal included in the reception signal, and if the URLLC data is included, demodulates the URLLC data addressed to the own device on the basis of the control signal. Furthermore, each of the user terminal devices 200 that uses the services using both of eMBB and URLLC demodulates eMBB data and demodulates URLLC data in the same manner as described above.

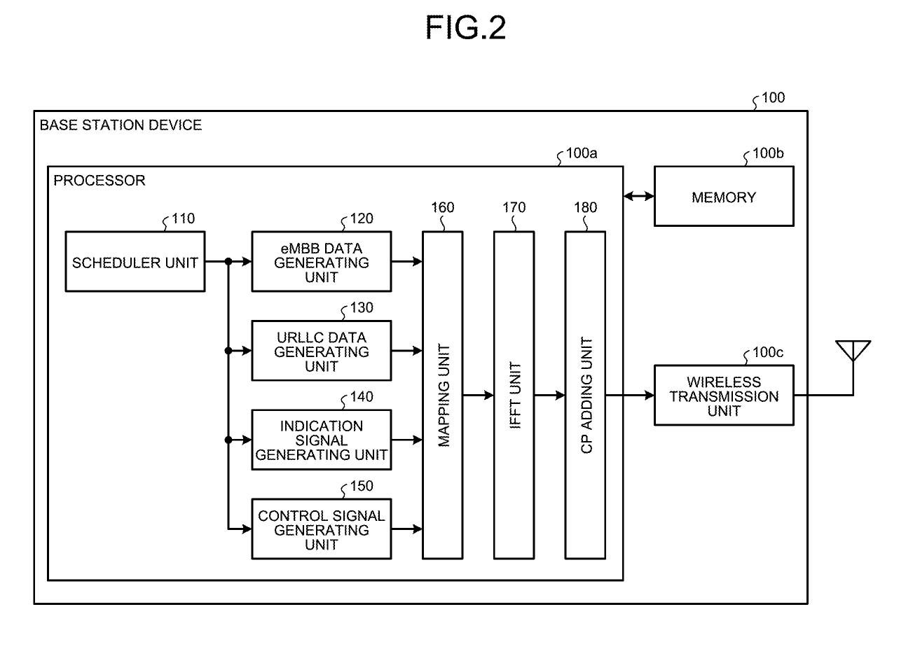

FIG. 2 is a block diagram illustrating a configuration of the base station device 100 according to the first embodiment. The base station device 100 illustrated in FIG. 2 includes a processor 100a, a memory 100b, and a wireless transmission unit 100c.

The processor 100a includes, for example, a central processing unit (CPU), a field programmable gate array (FPGA), or a digital signal processor (DSP), and integrally controls the entire base station device 100. Specifically, the processor 100a includes a scheduler unit 110, an eMBB data generating unit 120, a URLLC data generating unit 130, an indication signal generating unit 140, a control signal generating unit 150, a mapping unit 160, an inverse fast Fourier transform (IFFT) unit 170, and a cyclic prefix (CP) adding unit 180.

The scheduler unit 110 performs scheduling of allocating resources to eMBB data and URLLC data addressed to the plurality of user terminal devices 200. Specifically, the scheduler unit 110 estimates, for example, a channel state between the base station device 100 and each of the user terminal devices 200, and performs eMBB scheduling of determining, in accordance with the channel state, a resource to be allocated to eMBB data that is addressed to each of the user terminal devices 200. Further, the scheduler unit 110 determines whether URLLC data addressed to any of the user terminal devices 200 has been generated, and if the URLLC data has been generated, performs URLLC scheduling of allocating a resource to the URLLC data.

When performing the URLLC scheduling, the scheduler unit 110 arranges the URLLC data in a URLLC area that is provided in the resource area that is allocated to eMBB data. In other words, the resource for a transmission signal has an eMBB control channel area in which an eMBB control signal is arranged and an eMBB data area in which eMBB data is arranged, and, a URLLC area that is temporarily reserved as an area in which URLLC data is to be arranged is provided in the eMBB data area. Therefore, if URLLC data to be transmitted is generated, the scheduler unit 110 allocates the resource of the URLLC area to the URLLC data.

The eMBB data generating unit 120 generates eMBB data addressed to each of the user terminal devices 200, in accordance with the eMBB scheduling performed by the scheduler unit 110. In other words, the eMBB data generating unit 120 encodes and modulates the eMBB data addressed to each of the user terminal devices 200.

The URLLC data generating unit 130 generates URLLC data addressed to each of the user terminal devices 200, in accordance with the URLLC scheduling performed by the scheduler unit 110. In other words, the URLLC data generating unit 130 encodes and modulates the URLLC data addressed to each of the user terminal devices 200.

The indication signal generating unit 140 generates an indication signal indicating presence or absence of URLLC data, depending on whether the scheduler unit 110 has performed the URLLC scheduling. In other words, if URLLC data to be transmitted is absent and URLLC data is not arranged in the URLLC area, the indication signal generating unit 140 generates an indication signal indicating absence of URLLC data. Further, if URLLC data to be transmitted is present and the URLLC data is arranged in the URLLC area, the indication signal generating unit 140 generates an indication signal indicating presence of URLLC data.

Here, the indication signal generating unit 140 generates a signal including a plurality of bits, as the indication signal indicating presence or absence of URLLC data. In other words, for example, the indication signal indicating absence of URLLC data is a signal in which “0” is repeated multiple times, and the indication signal indicating presence of URLLC data is a signal in which “1” is repeated multiple times. In this manner, because the indication signal includes a plurality of bits, each of the user terminal devices 200 that receives the indication signal is less likely to make an error in determination of presence or absence of URLLC data, so that it becomes possible to realize ultra-high reliability of the URLLC data.

The control signal generating unit 150 generates a control signal of each of eMBB and URLLC in accordance with the eMBB scheduling and the URLLC scheduling performed by the scheduler unit 110. Specifically, the control signal generating unit 150 generates an eMBB control signal that includes information for identifying a resource to be allocated to eMBB data addressed to each of the user terminal devices 200 and includes information indicating a code rate of eMBB data, a modulation method of eMBB data, transmission power of eMBB data, and the like. Further, if URLLC data is arranged in the URLLC area, the control signal generating unit 150 generates a URLLC control signal that includes information for identifying a resource to be allocated to URLLC data addressed to each of the user terminal devices 200 and includes information indicating a code rate of URLLC data, a modulation method of URLLC data, transmission power of URLLC data, and the like.

The mapping unit 160 maps eMBB data, URLLC data, an indication signal, and a control signal, thereby generating a transmission signal. In other words, the mapping unit 160 arranges the eMBB data, the URLLC data, the indication signal, and the control signal in resources in accordance with scheduling.

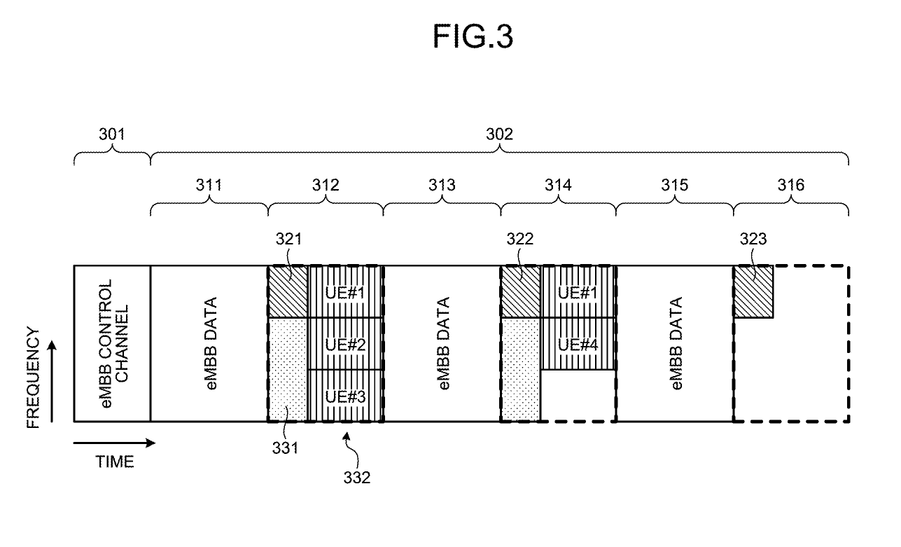

Specifically, the mapping unit 160 generates a transmission signal in which resources are allocated as illustrated in FIG. 3, for example. FIG. 3 is a diagram illustrating a specific example of allocation of resources with a frequency bandwidth corresponding to a predetermined number of subcarriers and duration of a single transmission time interval (TTI), for example. As illustrated in FIG. 3, the resource for the TTI includes an eMBB control channel area 301 and an eMBB data area 302. Further, the eMBB data area 302 includes a plurality of mini slots 311 to 316, where the mini slots 312, 314, and 316 are URLLC areas that are temporarily reserved as areas in which URLLC data is to be arranged. Therefore, eMBB data is mapped to the mini slots 311, 313, and 315, while indication signals 321 to 323, a URLLC control signal 331, and URLLC data 332 are mapped to the mini slots 312, 314, and 316.

The mapping unit 160 maps the eMBB control signal generated by the control signal generating unit 150 to the eMBB control channel area 301 and maps the eMBB data generated by the eMBB data generating unit 120 to the eMBB data area 302. Further, if the URLLC scheduling has been performed, the mapping unit 160 maps the URLLC control signal 331 generated by the control signal generating unit 150 and the URLLC data 332 generated by the URLLC data generating unit 130 to the mini slots 312, 314, and 316. Furthermore, the mapping unit 160 maps the indication signals 321 to 323 generated by the indication signal generating unit 140 to the mini slots 312, 314, and 316, respectively.

In this example, as illustrated in FIG. 3, the URLLC data is arranged in the mini slots 312 and 314, and therefore, each of the indication signals 321 and 322 includes, for example, a plurality of “1” indicating presence of URLLC data. In contrast, URLLC data is not arranged in the mini slot 316, and therefore, the indication signal 323 includes, for example, a plurality of “0” indicating absence of URLLC data. In URLLC, there is a requirement that a target over-the-air block error rate is 10⁻⁵, and it is desirable to set a signal to noise ratio (SNR) to, for example, about 12 dB to achieve the requirement. Further, if it is assumed that a link budget of, for example, 10 db is lost due to a wireless communication system, a total gain of, for example, 22 db is needed to achieve the requirement of URLLC. To obtain the gain as described above, it may be possible to obtain a gain of 18 db by repeating “1” or “0” 64 times in the indication signal and obtain a gain of 4 db by increasing transmission power, for example.

The URLLC control signal 331 mapped to each of the mini slots 312 and 314 includes information for identifying a frequency band of each piece of URLLC data addressed to UE#1 to UE#4. In other words, for example, pieces of URLLC data addressed to the three user terminal devices 200 identified by UE#1 to UE#3 are arranged in the mini slot 312, and the URLLC control signal 331 includes information for identifying the frequency bands of the respective pieces of URLLC data addressed to UE#1 to UE#3.

Further, URLLC data is mapped to only a part of the mini slot 314, and eMBB data is mapped to the rest of the area. Similarly, URLLC data is not mapped to the mini slot 316, and therefore, eMBB data is mapped to the whole area of the mini slot 316. In this manner, if URLLC data to be transmitted is absent, eMBB data is mapped to the mini slots 312, 314, and 316 that are the URLLC areas, so that it is possible to effectively use the resources. In particular, eMBB data is arranged in free areas of the URLLC areas, so that it is possible to allocate the maximum amount of resources to eMBB data and thus it is possible to increase capacity based on eMBB.

Meanwhile, while only the mini slots 312, 314, and 316 are used as the URLLC areas in the example described above, it may be possible to use all of the mini slots 311 to 316 as the URLLC areas. In this case, the indication signal indicating presence or absence of URLLC data is mapped to all of the mini slots 311 to 316.

Referring back to FIG. 2, the IFFT unit 170 performs inverse fast Fourier transform on the transmission signal generated by the mapping unit 160 and generates a transmission signal in the time domain. Then, the IFFT unit 170 outputs the transmission signal to the CP adding unit 180.

The CP adding unit 180 adds a CP to the transmission signal output from the IFFT unit 170. Then, the CP adding unit 180 outputs the transmission signal to which the CP is added to the wireless transmission unit 100c.

The memory 100b includes, for example, a random access memory (RAM), a read only memory (ROM), or the like, and stores therein various kinds of information when the processor 100a performs processes.

The wireless transmission unit 100c performs a wireless transmission process, such as digital-to-analog (D/A) conversion and up-conversion, on the transmission signal output from the CP adding unit 180. Then, the wireless transmission unit 100c transmits the transmission signal via an antenna.

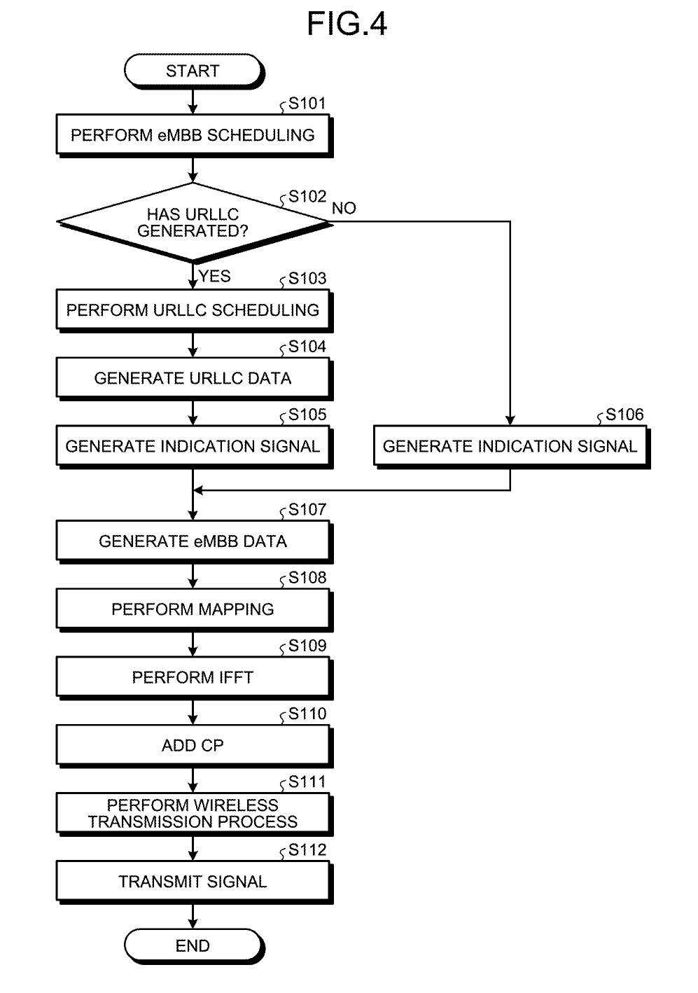

Next, a transmission process performed by the base station device 100 that is configured as described above will be described with reference to a flowchart illustrated in FIG. 4.

First, the scheduler unit 110 performs the eMBB scheduling of determining a resource to be allocated to eMBB data addressed to each of the user terminal devices 200, a code rate, and a modulation method (Step S101). The eMBB scheduling is performed based on, for example, a channel state of a downlink reported by each of the user terminal devices 200. In the eMBB scheduling, it is determined that eMBB data addressed to each of the user terminal devices 200 is arranged in the eMBB data area in each TTI.

Further, the scheduler unit 110 determines whether URLLC data addressed to any of the user terminal devices 200 has been generated (Step S102). As a result of the determination, if URLLC data to be transmitted has been generated (Yes at Step S102), the scheduler unit 110 performs the URLLC scheduling of determining a resource to be allocated to the URLLC data, a code rate, and a modulation method (Step S103). The URLLC scheduling is performed based on, for example, a channel state of a downlink reported by each of the user terminal devices 200. In the URLLC scheduling, it is determined that URLLC data addressed to each of the user terminal devices 200 is arranged in the URLLC area that is provided in the eMBB data area in each TTI.

Then, the eMBB data generating unit 120, the URLLC data generating unit 130, the indication signal generating unit 140, and the control signal generating unit 150 are notified of a result of the scheduling, and the URLLC data generating unit 130 generates URLLC data that is to be arranged in the URLLC area (Step S104). In other words, the URLLC data generating unit 130 encodes and modulates the URLLC data using the code rate and the modulation method determined through the URLLC scheduling. Further, the indication signal generating unit 140 generates an indication signal including a plurality of bits indicating presence of URLLC data (Step S105). Specifically, an indication signal including a plurality of “1” is generated, for example.

In contrast, as a result of the determination at Step S102, if URLLC data to be transmitted has not been generated (No at Step S102), the eMBB data generating unit 120, the indication signal generating unit 140, and the control signal generating unit 150 are notified of a result of the eMBB scheduling. Then, the indication signal generating unit 140 generates an indication signal including a plurality of bits indicating absence of URLLC data (Step S106). Specifically, an indication signal including a plurality of “0” is generated, for example.

Further, regardless of the presence or absence of URLLC data, the eMBB data generating unit 120 generates eMBB data to be arranged in the eMBB data area (Step S107). In other words, the eMBB data generating unit 120 encodes and modulates the eMBB data using the code rate and the modulation method determined through the eMBB scheduling. Meanwhile, when URLLC data is arranged in the URLLC area, it may be possible to cancel transmission of eMBB data that is scheduled to be arranged in the same area.

If eMBB data is generated, the control signal generating unit 150 identifies a resource in the eMBB data area that is allocated to the eMBB data addressed to each of the user terminal devices 200, and generates a control signal for giving a notice of a code rate of the eMBB data, a modulation method of the eMBB data, and transmission power of the eMBB data. Further, if URLLC data is generated, the control signal generating unit 150 identifies a resource in the URLLC area that is allocated to the URLLC data addressed to each of the user terminal devices 200, and generates a control signal for giving a notice of a code rate of the URLLC data, a modulation method of the URLLC data, and transmission power of the URLLC data.

Then, the mapping unit 160 maps the eMBB data, the URLLC data, the indication signal, and the control signal to each of the areas in TTI (Step S108). In other words, as illustrated in FIG. 3, the eMBB control signal is mapped to the eMBB control channel area 301 and the eMBB data is mapped to the eMBB data area 302. Further, if URLLC data is generated, the URLLC control signal 331 and the URLLC data 332 are mapped to the mini slots 312, 314, and 316 that are the URLLC areas. Then, the indication signals 321 to 323 each including a plurality of bits indicating presence or absence of URLLC data are mapped to the respective URLLC areas. Thus, a transmission signal is generated.

The transmission signal is subjected to inverse fast Fourier transform by the IFFT unit 170 (Step S109), and transformed to a transmission signal in the time domain. Then, the CP adding unit 180 adds a CP to the transmission signal (Step S110), and the wireless transmission unit 100c performs a wireless transmission process on the transmission signal (Step S111). Thereafter, the transmission signal is transmitted to the user terminal device 200 via the antenna (Step S112).

As described above, the URLLC area in which URLLC data is to be arranged is provided in the eMBB data area such that URLLC data is arranged in the URLLC area when URLLC data is present and such that eMBB data is arranged in the URLLC area when URLLC data is absent. Then, the indication signal including a plurality of bits indicating whether URLLC data has been arranged in the URLLC area is arranged in each of the URLLC areas. Therefore, it is possible to transmit URLLC data with low latency when URLLC data is generated, and use the resource of the URLLC area to transmit eMBB data when URLLC data is not generated. As a result, the resources are not wasted regardless of the presence or absence of URLLC data, so that it is possible to effectively use the resources. Furthermore, the indication signal including a plurality of bits indicating presence or absence of URLLC data is arranged in the URLLC area, so that is is possible to give a notice of the presence or absence of URLLC data with high reliability and realize ultra-high reliability of the URLLC data.

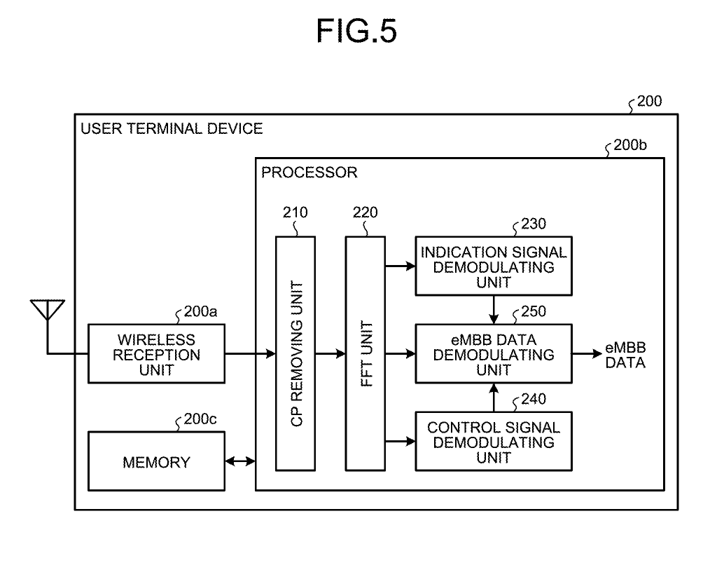

Next, a configuration of the user terminal device 200 will be described. FIG. 5 is a block diagram illustrating a configuration of the user terminal device 200 according to the first embodiment. The user terminal device 200 illustrated in FIG. 5 is a user terminal device that uses services related to eMBB, and includes a wireless reception unit 200a, a processor 200b, and a memory 200c.

The wireless reception unit 200a receives a signal via an antenna and performs a wireless reception process, such as down-conversion and analog-to-digital (A/D) conversion, on the reception signal. Then, the wireless reception unit 200a outputs the reception signal to the processor 200b.

The processor 200b includes, for example, a CPU, an FPGA, a DSP, or the like and integrally controls the entire user terminal device 200. Specifically, the processor 200b includes a CP removing unit 210, a fast Fourier transform (FFT) unit 220, an indication signal demodulating unit 230, a control signal demodulating unit 240, and an eMBB data demodulating unit 250.

The CP removing unit 210 removes a CP that has been added to the reception signal. Then, the CP removing unit 210 outputs the reception signal from which the CP has been removed to the FFT unit 220.

The FFT unit 220 performs the fast Fourier transform on the reception signal output from the CP removing unit 210, and transforms the reception signal to a reception signal in the frequency domain. Then, the FFT unit 220 outputs the reception signal to the indication signal demodulating unit 230, the control signal demodulating unit 240, and the eMBB data demodulating unit 250.

The indication signal demodulating unit 230 demodulates the indication signal that is arranged in the URLLC area in the reception signal. In other words, because the positions of the URLLC area and the indication signal in the URLLC area are already known, the indication signal demodulating unit 230 demodulates the indication signal in each of the URLLC areas. As a result, the indication signal demodulating unit 230 acquires a plurality of bits indicating whether URLLC data is included in each of the URLLC areas. Then, the indication signal demodulating unit 230 determines whether URLLC data is included in each of the URLLC areas on the basis of the plurality of acquired bits. Specifically, the indication signal demodulating unit 230 determines that URLLC data is included when the number of bits indicating presence of URLLC data among the plurality of acquired bits is larger, and determines that URLLC data is not included when the number of bits indicating absence of URLLC data among the plurality of acquired bits is larger.

The control signal demodulating unit 240 demodulates the control signal arranged in the eMBB control channel area in the reception signal. In other words, the control signal demodulating unit 240 demodulates the eMBB control signal and acquires information on the resource allocated to the eMBB data that is addressed to the own device and information on a code rate of the eMBB data, a modulation method of the eMBB data, and the like.

The eMBB data demodulating unit 250 demodulates the eMBB data arranged in the eMBB data area in the reception signal. In this case, the eMBB data demodulating unit 250 excludes, from the eMBB data area on the basis of a demodulation result of the indication signal, the area in which the URLLC data has been arranged, and specifies, from the eMBB data area in which the URLLC data has been excluded, a resource of the eMBB data addressed to the own device on the basis of a demodulation result of the control signal. Then, the eMBB data demodulating unit 250 demodulates the eMBB data addressed to the own device on the basis of the code rate, the modulation method, and the like indicated by the control signal.

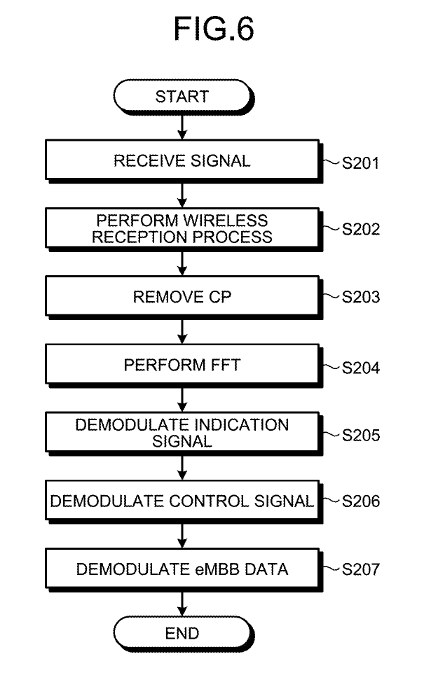

Next, a reception process performed by the user terminal device 200 that is related to eMBB and is configured as described above will be described with reference to a flowchart illustrated in FIG. 6.

A signal transmitted from the base station device 100 is received via the antenna (Step S201), and the wireless reception unit 200a performs a wireless reception process on the reception signal (Step S202). Then, the CP removing unit 210 removes the CP that has been added to the reception signal (Step S203), and the FFT unit 220 performs the fast Fourier transform on the reception signal (Step S204), so that the reception signal in the frequency domain is obtained.

Because the URLLC area is provided in the eMBB data area of the reception signal and the resource of the URLLC area is already known, the indication signal demodulating unit 230 demodulates the indication signal arranged in the URLLC area (Step S205). As a result, a plurality of bits indicating whether URLLC data is included in the URLLC area are acquired, and it is determined whether URLLC data is included in the URLLC area on the basis of the plurality of acquired bits. Then, it is determined that eMBB data is arranged in the URLLC area for which it is determined that URLLC data is not included.

Further, the control signal demodulating unit 240 demodulates the control signal arranged in the eMBB control channel area in the reception signal (Step S206), the resource that is allocated to eMBB data addressed to the own device is identified, and the code rate of the eMBB data, the modulation method of the eMBB data, and the like are identified. Therefore, the eMBB data demodulating unit 250 acquires the eMBB data addressed to the own device from the reception signal and demodulates the acquired eMBB data (Step S207).

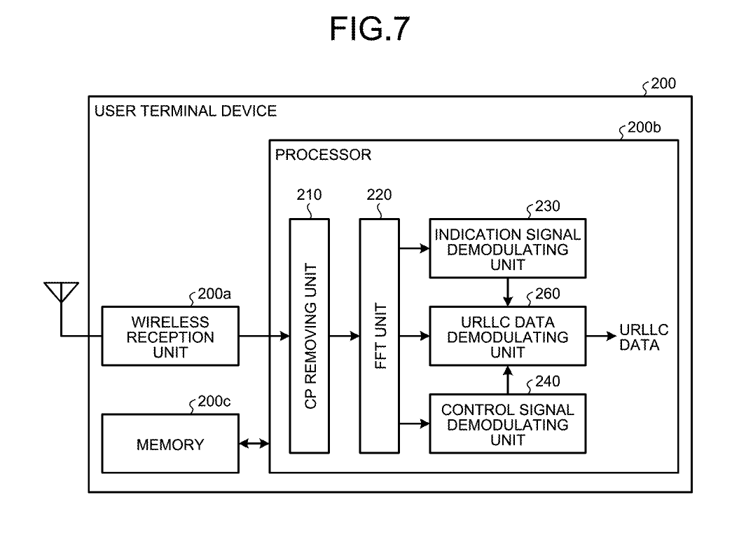

FIG. 7 is a block diagram illustrating another configuration of the user terminal device 200 according to the first embodiment. In FIG. 7, the same components as those of FIG. 5 are denoted by the same reference symbols, and explanation thereof will be omitted. The user terminal device 200 illustrated in FIG. 7 is a user terminal device that uses services related to URLLC and includes the wireless reception unit 200a, the processor 200b, and the memory 200c similarly to the user terminal device 200 illustrated in FIG. 5. However, the processor 200b of the user terminal device 200 illustrated in FIG. 7 includes a URLLC data demodulating unit 260 instead of the eMBB data demodulating unit 250 illustrated in FIG. 5.

If it is determined that the reception signal includes URLLC data based on the demodulation result of the indication signal, the URLLC data demodulating unit 260 demodulates the URLLC data that is addressed to the own device and that is arranged in the URLLC area in the reception signal. In this case, the URLLC data demodulating unit 260 identifies the resource of the URLLC data addressed to the own device from the URLLC area on the basis of the demodulation result of the URLLC control signal. Then, the URLLC data demodulating unit 260 demodulates the URLLC data addressed to the own device on the basis of the code rate, the modulation method, and the like indicated by the URLLC control signal.

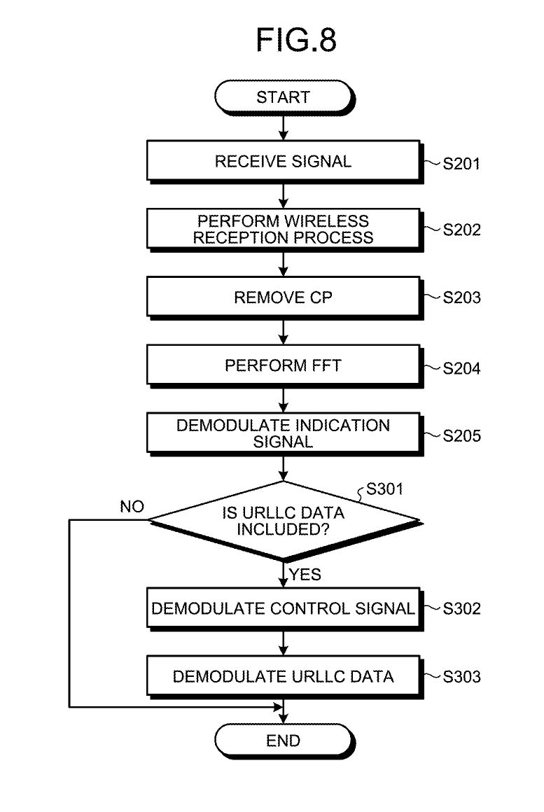

Next, a reception process performed by the user terminal device 200 that is related to URLLC and is configured as described above will be described below with reference to a flowchart illustrated in FIG. 8. In FIG. 8, the same processes as those of FIG. 6 are denoted by the same reference symbols, and detailed explanation thereof will be omitted.

A signal transmitted from the base station device 100 is obtained as a reception signal in the frequency domain via the antenna, the wireless reception unit 200a, the CP removing unit 210, and the FFT unit 220 (Step S201 to S204). Then, the indication signal demodulating unit 230 demodulates the indication signal that is arranged in the URLLC area of the reception signal (Step S205), and it is determined whether URLLC data is included in the URLLC area (Step S301). Specifically, it is determined that URLLC data is included in the URLLC area when the number of bits indicating presence of URLLC data among the plurality of bits included in the indication signal is larger. In contrast, it is determined that URLLC data is not included in the URLLC area when the number of bits indicating absence of URLLC data among the plurality of bits included in the indication signal is larger.

If URLLC data is not included in the URLLC area (NO at Step S301), the process is terminated because URLLC data addressed to the own device is absent. In contrast, if URLLC data is included in the URLLC area (YES at Step S301), the control signal demodulating unit 240 demodulates the URLLC control signal (Step S302). Then, the resource allocated to the URLLC data addressed to the own device is identified from the demodulation result of the URLLC control signal, and the code rate, the modulation method, and the like of the URLLC data addressed to the own device are identified. With use of the identified information, the URLLC data demodulating unit 260 demodulates the URLLC data addressed to the own device (Step S303).

As described above, according to the first embodiment, the URLLC area that is temporarily reserved as an area in which URLLC data is to be arranged is provided in the eMBB data area, and if URLLC data is generated, the URLLC data is transmitted using the resource of the URLLC area. Further, the indication signal including a plurality of bits indicating presence or absence of URLLC data is arranged in the URLLC area. Therefore, it is possible to promptly transmit the URLLC data without any delay when the URLLC data is generated, and it is possible to transmit eMBB data using the resource of the URLLC area when URLLC data is not generated. Furthermore, the user terminal device on the reception side is able to recognize the presence or absence of URLLC data with accuracy by using the indication signal including a plurality of bits, and reliably acquire the URLLC data addressed to the own device from the reception signal. As a result, it is possible to effectively use the resources while maintaining high reliability and low latency of the URLLC data.

Moreover, in the first embodiment as described above, the user terminal device 200 related to eMBB and the user terminal device 200 related to URLLC are separated, but it may be possible to cause the single user terminal device 200 to demodulate both of the eMBB data and the URLLC data. In this case, the processor 200b of the user terminal device 200 includes both of the eMBB data demodulating unit 250 illustrated in FIG. 5 and the URLLC data demodulating unit 260 illustrated in FIG. 7.

Further, in the first embodiment as described above, some of the mini slots in the eMBB data area are used as the URLLC areas, but it may be possible to use all of the mini slots in the eMBB data area as the URLLC areas. In other words, it may be possible to arrange the indication signals including a plurality of bits indicating presence or absence of URLLC data in all of the mini slots included in the eMBB data area, and arrange eMBB data in the URLLC area in which URLLC data is not included.

### [b] Second Embodiment

A feature of a second embodiment is that the plurality of bits indicating presence or absence of URLLC data is also used as a reference signal for demodulation.

Configurations of a base station device and a user terminal device according to the second embodiment are the same as those of the first embodiment, and therefore, explanation thereof will be omitted. In the second embodiment, the indication signal generating unit 140 generates a different indication signal from that of the first embodiment.

Specifically, the indication signal generating unit 140 generates, as the indication signal indicating presence or absence of URLLC data, a signal including a plurality of bits that serve as a reference signal for demodulation. More specifically, the indication signal generating unit 140 generates multiple-bit indication signals that are orthogonal to each other between when URLLC data is present and when URLLC data is absent. Therefore, for example, the indication signal generating unit 140 generates (0, 0, 0, 0) as the indication signal indicating absence of URLLC data and generates (0, 1, 0, 1) as the indication signal indicating presence of URLLC data. These indication signals are orthogonal to each other, and the first bits and the third bits of both of the indication signals are “0”. Therefore, the user terminal device 200 on the reception side is able to perform channel estimation by using the first bit and the third bit of the indication signal as a known reference signal, and thus it is possible to use the indication signal as a reference signal for demodulation. Meanwhile, in this example, a case has been described in which the indication signals are 4-bit signals for simplicity of explanation, but the indication signals may be signals including more bits.

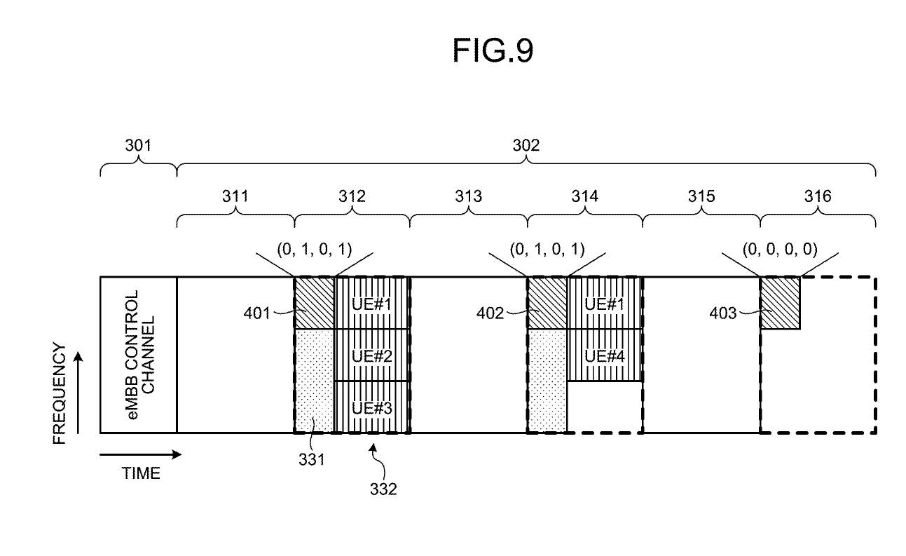

FIG. 9 is a diagram illustrating a specific example of resource allocation according to the second embodiment. In FIG. 9, the same components as those of FIG. 3 are denoted by the same reference symbols.

As illustrated in FIG. 9, the eMBB data area 302 includes the plurality of mini slots 311 to 316, where the mini slots 312, 314, and 316 are URLLC areas that are temporarily reserved as areas in which URLLC data is to be arranged. Therefore, eMBB data is mapped to the mini slots 311, 313, and 315, while indication signals 401 to 403, the URLLC control signal 331, and the URLLC data 332 are mapped to the mini slots 312, 314, and 316.

The eMBB control signal is mapped to the eMBB control channel area 301, and the eMBB data is mapped to the eMBB data area 302. Further, if URLLC data that is to be transmitted is present, the URLLC control signal 331 and the URLLC data 332 are mapped to the mini slots 312, 314, and 316. Furthermore, the indication signals 401 to 403 are mapped to the mini slots 312, 314, and 316.

In this example, as illustrated in FIG. 9, the URLLC data is arranged in the mini slots 312 and 314, and therefore, each of the indication signals 401 and 402 includes, for example, four bits of (0, 1, 0, 1) indicating presence of URLLC data. In contrast, URLLC data is not arranged in the mini slot 316, and therefore, the indication signal 403 includes, for example, four bits of (0, 0, 0, 0) indicating absence of URLLC data. Therefore, (0, 1, 0, 1) in the case where URLLC data is present is used as a reference signal for demodulating the URLLC data 332. In contrast, (0, 0, 0, 0) in the case where URLLC data is absent is used as a reference signal for demodulating eMBB data arranged in the URLLC area. In this manner, by setting the indication signals corresponding to presence and absence of URLLC data as signals that are orthogonal to each other, it is possible to use the indication signal as a reference signal for demodulating the URLLC data or the eMBB data, and it becomes not necessary to separately allocate a resource to the reference signal. As a result, it is possible to effectively use the resources.

The user terminal device 200 that receives the signal in which the resources are allocated as illustrated in FIG. 9 demodulates the indication signals 401 to 403 in the URLLC areas and determines whether URLLC data is arranged in the URLLC areas on the basis of the demodulation result. Specifically, it is determined whether URLLC data is present or absent depending on which of (0, 0, 0, 0) indicating absence of URLLC data and (0, 1, 0, 1) indicating presence of URLLC data has a higher degree of match with the demodulation result of the indication signal. Then, for example, channel estimation is performed using the first bit and the third bit that are common between the two indication signals, and the URLLC data or the eMBB data is demodulated. Meanwhile, if the presence or absence of URLLC data is determined, it is determined whether the transmitted indication signal is (0, 0, 0, 0) or (0, 1, 0, 1); therefore, it may be possible to perform channel estimation using all of the bits as a known reference signal, instead of using only the first bit and the third bit.

As described above, according to the second embodiment, the indication signals that include a plurality of bits so as to correspond to presence and absence of URLLC data and so as to be orthogonal to each other are arranged in the URLLC area. Therefore, it is possible to use the indication signal indicating presence or absence of URLLC data as a reference signal for demodulation, so that it is not necessary to separately allocate a resource to the reference signal. As a result, it is possible to effectively use the resources while maintaining high reliability and low latency of the URLLC data.

### [c] Third Embodiment

A feature of a third embodiment is that a URLLC area is provided in a transmission signal that is transmitted from multiple antennas, and an indication signal is mapped to a different frequency for each of the antennas.

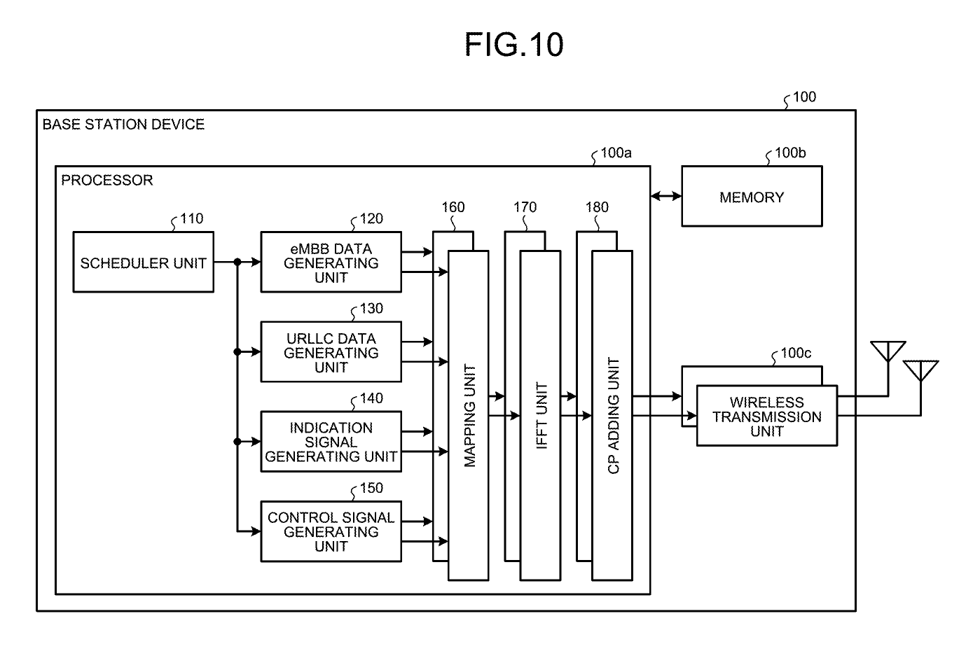

FIG. 10 is a block diagram illustrating a configuration of the base station device 100 according to the third embodiment. In FIG. 10, the same components as those of FIG. 2 are denoted by the same reference symbols. The base station device 100 illustrated in FIG. 10 includes multiple antennas, and includes the mapping unit 160, the IFFT unit 170, the CP adding unit 180, and the wireless transmission unit 100c for each of the antennas. Operation of each of the mapping unit 160, the IFFT unit 170, the CP adding unit 180, and the wireless transmission unit 100c is the same as that of the first embodiment, and therefore, explanation thereof will be omitted. The base station device 100 according to the third embodiment transmits signals from the multiple antennas. The transmission signals may be the same signals or different signals. When different signals are transmitted from the multiple antennas, the base station device 100 may perform transmission based on multi-input multi-output (MIMO).

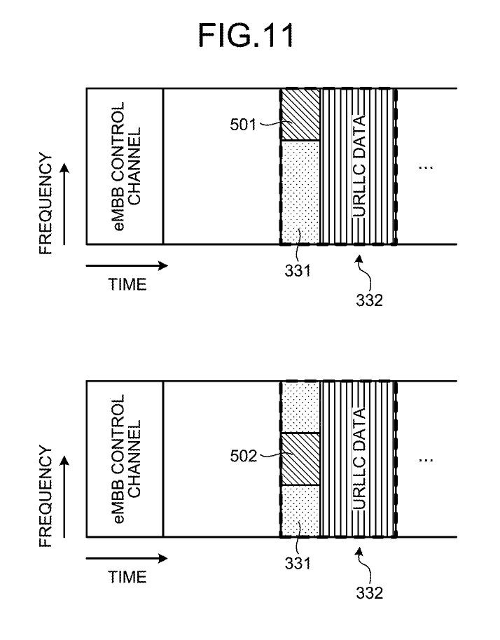

FIG. 11 is a diagram illustrating a specific example of resource allocation according to the third embodiment. In FIG. 11, the same processes as those of FIG. 3 are denoted by the same reference symbols.

In the third embodiment, because the base station device 100 includes the multiple antennas, the mapping unit 160 maps eMBB data and URLLC data to a transmission single that is transmitted from a corresponding antenna. Specifically, as illustrated in the upper figure of FIG. 11, the URLLC control signal 331, the URLLC data 332, and an indication signal 501 are mapped to a mini slot serving as the URLLC area in the transmission signal that is transmitted from a single antenna. In contrast, as illustrated in the lower figure of FIG. 11, the URLLC control signal 331, the URLLC data 332, and an indication signal 502 are mapped to a mini slot serving as the URLLC area in the transmission signal that is transmitted from a different antenna.

The indication signals 501 and 502 are signals that are orthogonal to each other in accordance with presence and absence of the URLLC data, and the indication signal 501 and the indication signal 502 are orthogonal sequence signals. Specifically, for example, the indication signal 501 includes four bits of (0, 0, 0, 0) when URLLC data is absent and includes four bits of (0, 1, 1, 0) when URLLC data is present. In contrast, for example, the indication signal 502 includes four bits of (0, 1, 0, 1) when URLLC data is absent and includes four bits of (0, 0, 1, 1) when URLLC data is present. The four 4-bit signals are orthogonal to one another. In this manner, by setting the indication signals corresponding to presence and absence of URLLC data for each of the antennas as signals that are orthogonal to each another, it is possible to use the indication signal as a reference signal for demodulating the URLLC data or the eMBB data, and it becomes not necessary to separately allocate a resource to the reference signal. As a result, it is possible to effectively use the resources.

Further, the indication signals 501 and 502 that are transmitted from different antennas are mapped to different frequencies. Therefore, the user terminal device 200 on the reception side is able to perform channel estimation on each of channels from each of the antennas of the base station device 100, and accurately demodulate the URLLC data or the eMBB data.

As described above, according to the third embodiment, when the base station device includes multiple antennas, the indication signals that include a plurality of bits so as to correspond to presence and absence of URLLC data and so as to be orthogonal to each other are arranged in the URLLC area of a signal transmitted from each of the antennas. Therefore, it is possible to perform channel estimation for each of the channels by using the indication signal indicating presence or absence of URLLC data as a reference signal for demodulation, and it becomes not necessary to separately allocate a resource to the reference signal. As a result, it is possible to effectively use the resources while maintaining high reliability and low latency of the URLLC data.

### [d] Fourth Embodiment

A feature of a fourth embodiment is that eMBB data and URLLC data that is addressed to a different user terminal device are mapped in a diffuse manner in the URLLC area.

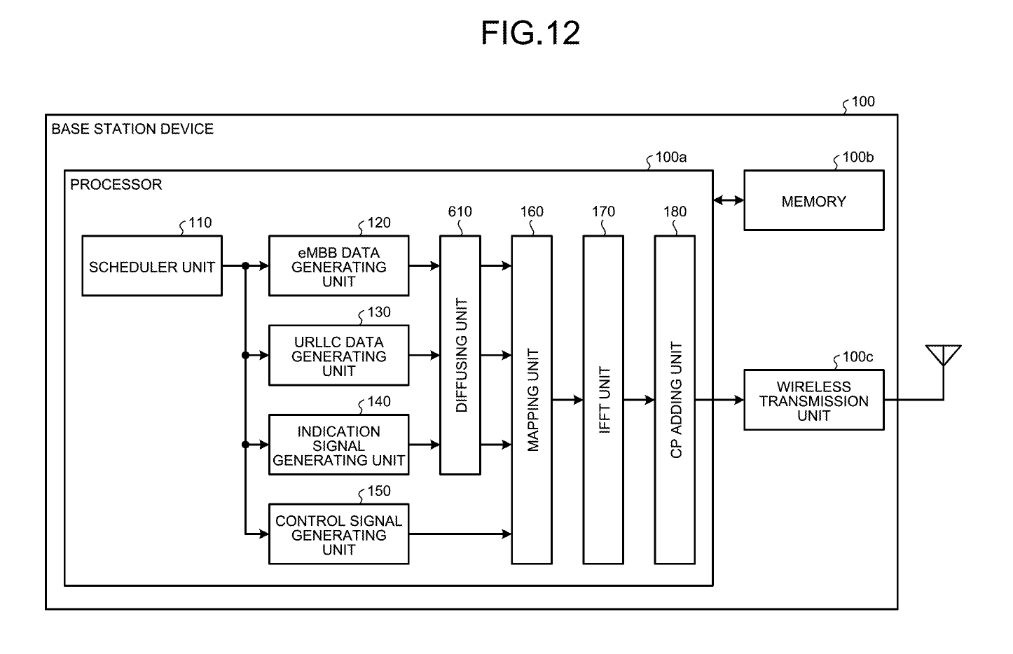

FIG. 12 is a block diagram illustrating a configuration of the base station device 100 according to the fourth embodiment. In FIG. 12, the same components as those of FIG. 2 are denoted by the same reference symbols, and explanation thereof will be omitted. The base station device 100 illustrated in FIG. 12 has a configuration obtained by adding a diffusing unit 610 to the base station device 100 illustrated in FIG. 2.

The diffusing unit 610 diffuses eMBB data generated by the eMBB data generating unit 120, URLLC data generated by the URLLC data generating unit 130, and an indication signal generated by the indication signal generating unit 140. In other words, the diffusing unit 610 diffuses the eMBB data, the URLLC data, and the indication signal by using different codes or sequences (for example, Zadoff-Chu sequence) for the respective user terminal devices 200.

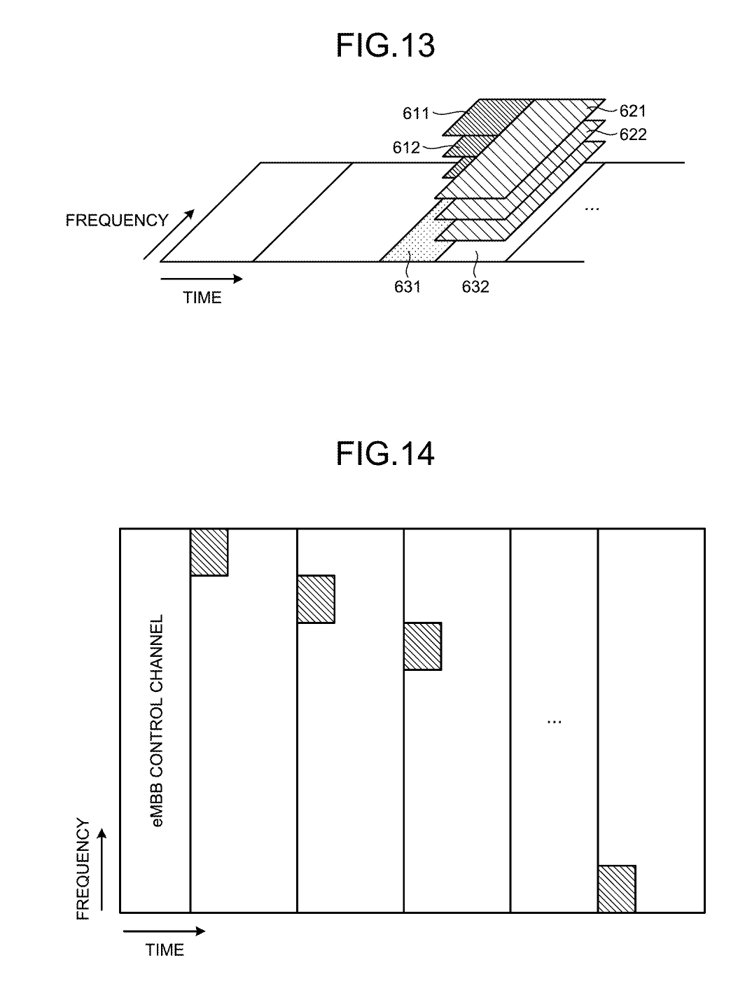

FIG. 13 is a diagram illustrating a specific example of resource allocation according to the fourth embodiment. In FIG. 13, similarly to FIG. 3, a specific example of allocation of resources with a frequency bandwidth corresponding to a predetermined number of subcarriers is illustrated as one example.

As illustrated in FIG. 13, in the URLLC area provided in the eMBB data area, indication signals 611 and 612 that are diffused by using different codes are multiplexed, and pieces of URLLC data 621, 622 and eMBB data 632 are also multiplexed. In other words, the eMBB data and the URLLC data addressed to the different user terminal devices 200 are multiplexed in the URLLC area. Further, the URLLC control signal 631 is arranged in the URLLC area.

The eMBB data, the URLLC data, and the indication signal are diffused by the diffusing unit 610 as described above. In other words, the URLLC data 621 addressed to any of the user terminal devices 200 and the indication signal 611 corresponding to the URLLC data 621 are diffused by using a code unique to the user terminal device 200. Similarly, the URLLC data 622 and the indication signal 612 addressed to the different user terminal device 200 are diffused by using a different code. Furthermore, the indication signal addressed to the user terminal device 200 that is a destination of the eMBB data 632 is diffused by using a code unique to the subject user terminal device 200.

In addition, the indication signal indicating absence of URLLC data and the indication signal indicating presence of URLLC data addressed to each of the user terminal devices 200 are different from each other. Specifically, the indication signal indicating absence of URLLC data includes, for example, four bits of (0, 0, 0, 0). In contrast, the indication signal indicating presence of URLLC data includes, for example, four bits of (0, 0, 1, 1), (0, 1, 1, 0), or (0, 1, 0, 1) depending on the user terminal device 200 serving as a destination. In this manner, the eMBB data, the URLLC data, and the indication signal for different destinations are diffused and multiplexed in the single URLLC area, so that it is possible to effectively use the resources. Further, because the indication signals are different from one another, it is possible to use a corresponding indication signal as a reference signal for demodulating eMBB data and URLLC data.

As described above, according to the fourth embodiment, the eMBB data and the URLLC data are diffused by using different codes for respective user terminal devices serving as destinations, and multiplexed in the single URLLC area. Further, signals including different bits are mapped, as the indication signals respectively corresponding to the multiplexed eMBB data and URLLC data, to the URLLC area. Therefore, it is possible to further map eMBB data to the URLLC area in which the URLLC data is mapped, and at the same time, it is possible to use the indication signals corresponding to the eMBB data and the URLLC data as reference signals. As a result, it is possible to effectively use the resources.

Meanwhile, in the first to the fourth embodiments as described above, a mini slot serving as the URLLC area is provided in a part of the eMBB data area, but it may be possible to use all of mini slots in the eMBB data area as the URLLC areas. In other words, it may be possible to map the indication signals to all of the mini slots included in the eMBB data area, and give a notice indicating whether URLLC data is mapped to each of the mini slots. In this case, eMBB data is mapped to a mini slot in which the indication signal indicating absence of the URLLC data is mapped. Further, it may be possible to map the indication signal to a mini slot in which URLLC data is mapped and prevent the indication signal from being mapped to a mini slot in which URLLC data is not mapped. With this configuration, the terminal device on the reception side is able to determine whether URLLC data is included in the mini slot in accordance with presence or absence of the indication signal.

Furthermore, it may be possible to map the indication signal to a different frequency in each of the URLLC areas. In other words, as illustrated in FIG. 14 for example, it may be possible to map indication signals to different frequencies (oblique hatching in the figure) in different mini slots based on a frequency-hopping method. When these indication signals are used as reference signals for demodulation, it is possible to perform channel estimation on all of bandwidths by using the indication signals in past mini slots. The mini slots are relatively short unit times, and therefore, even when the indication signals mapped to the past mini slots are used as the reference signals, the channel state is not largely changed and demodulation accuracy is not reduced.

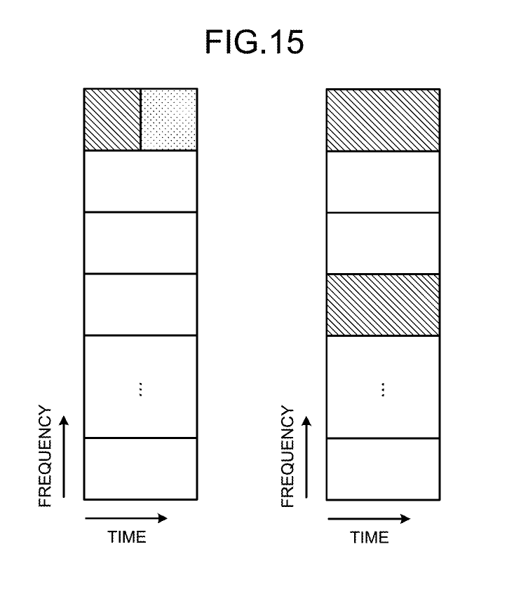

In the mini slot of the URLLC area, the indication signal and the URLLC control signal may be time-multiplexed. Specifically, as illustrated in the left figure of FIG. 15 for example, an indication signal (oblique hatching in the figure) and a URLLC control signal (dot hatching in the figure) may be time-multiplexed in a part of frequency bands of a single orthogonal frequency division multiplexing (OFDM) symbol. Further, when signals at a plurality ports are to be transmitted, indication signals of the respective ports may be frequency-multiplexed. Specifically, as illustrated in the right figure of FIG. 15 for example, indication signals (oblique hatching in the figure) used as reference signals may be frequency-multiplexed in different frequency bands of the single OFDM symbol. In this case, for example, it may be possible to use space frequency block coding (SFBC). Furthermore, indication signals of the respective ports may be code-multiplexed.

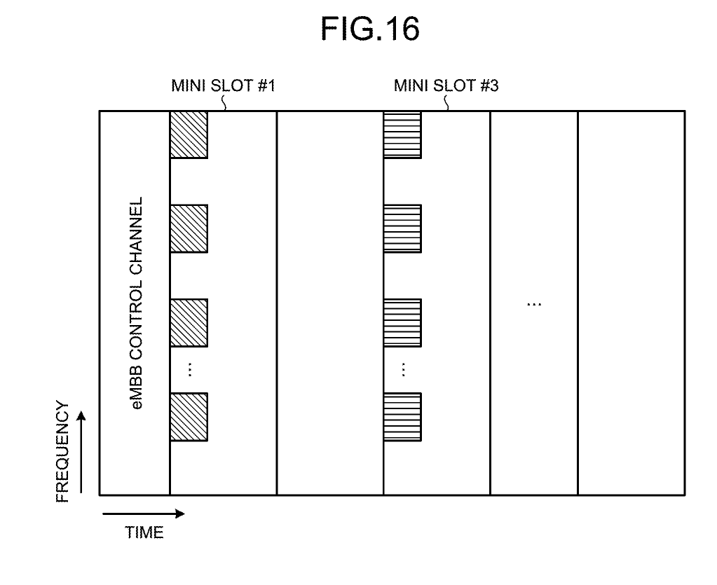

Moreover, as illustrated in FIG. 16 for example, indication signals serving as reference signals may be arranged in a diffuse manner in a plurality of physical resource blocks of a single mini slot. In other words, for example, indication signals (oblique hatching in the figure) of (0, 1, 0, 1) indicating presence of URLLC data are arranged in a plurality of physical resource blocks with different frequencies in a mini slot #1 in FIG. 16. In contrast, indication signals (horizontal line hatching in the figure) of (0, 0, 0, 0) indicating presence of eMBB data instead of URLLC data are arranged in a plurality of physical resource blocks with different frequencies of a mini slot #3. Even in this case, the terminal device on the reception side is able to determine whether the mini slot includes the URLLC data or the eMBB data by using the indication signals arranged in the physical resource blocks of each of the mini slots. Furthermore, by using the indication signals as the reference signals, it is possible to demodulate the URLLC data or the eMBB data in each of the mini slots. Moreover, because the indication signals are arranged in a diffuse manner in a plurality of physical resource blocks with different frequencies, it is possible to achieve frequency diversity effects, so that is is possible to improve reliability of transmission of the indication signals.

Meanwhile, when eMBB data is re-transmitted, it may be possible to re-transmit only the eMBB data without re-transmitting URLLC data for which low latency is needed. Further, when the indication signal is used as the reference signal, it may be possible to use a reference signal unique to each of the terminal devices on the reception side. Specifically, for example, it may be possible to determine a reference signal for each of the terminal devices based on cell-radio network temporary identifier (C-RNTI) as identifiers of the terminal devices.

According to one aspect of the base station device, the terminal device, and the transmission method disclosed in the present application, it is possible to effectively use resources.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station device comprising:
a processor that executes a process including
generating first data,
generating an indication signal including a plurality of bits that indicate whether second data that is transmitted at a lower latency than the first data is generated, and
generating a transmission signal by mapping the generated indication signal and one of the first data and the second data to each of predetermined unit areas of a resource; and
a transmitter configured to transmit the transmission signal generated by the processor.

2. The base station device according to claim 1, wherein the generating the indication signal includes generating the indication signal including a plurality of bits such that a portion of the bits are the same and a remaining portion of the bits are different between when the second data is generated and when the second data is not generated.

3. The base station device according to claim 1, wherein the generating the indication signal includes generating indication signals that include a plurality of bits so as to be orthogonal to each other between when the second data is generated and when the second data is not generated.

4. The base station device according to claim 1, wherein the generating the transmission signal includes, when the second data is generated, performing code-multiplexing on the first data and the second data and mapping the first data and the second data to an area at a same frequency and a same time.

5. The base station device according to claim 1, wherein the generating the transmission signal includes, when the second data is generated, performing frequency-multiplexing on the indication signal and a control signal on the second data and mapping the indication signal and the control signal.

6. The base station device according to claim 1, wherein the generating the transmission signal includes, when the second data is generated, performing time-multiplexing on the indication signal and a control signal on the second data and mapping the indication signal and the control signal.

7. The base station device according to claim 1, wherein the generating the transmission signal includes arranging indication signals in a diffuse manner at different frequencies in a single unit area of a resource.

8. The base station device according to claim 1, wherein the generating the transmission signal includes mapping indication signals to different frequencies in a plurality of unit areas of a resource.

9. A terminal device comprising:
a receiver configured to receive a reception signal in which one of first data and second data that is transmitted with low latency as compared to the first data is mapped to each of predetermined unit areas of a resource and in which an indication signal including a plurality of bits indicating presence or absence of the second data is mapped to each of the unit areas; and
a processor that executes a process including
determining whether the second data is included in each of the unit areas of a resource in the reception signal, on the basis of the indication signal mapped in the reception signal, and
demodulating one of the first data and the second data on the basis of a determination result obtained at the determining.

10. The terminal device according to claim 9, wherein the demodulating includes performing channel estimation by using the plurality of bits included in the indication signal mapped in the reception signal, and demodulating one of the first data and the second data.

11. A wireless communication system comprising:
a base station device; and
a terminal device, wherein
the base station device includes:
a first processor that executes a process including
generating first data,
generating an indication signal including a plurality of bits that indicate whether second data that is transmitted at a lower latency than the first data is generated, and
generating a transmission signal by mapping the generated indication signal and one of the first data and the second data to each of predetermined unit areas of a resource; and
a transmitter configured to transmit the transmission signal generated by the first processor, and
the terminal device includes:
a receiver configured to receive the transmission signal transmitted by the transmitter; and
a second processor that executes a process including
determining whether the second data is included in each of the unit areas of a resource in the reception signal, on the basis of the indication signal mapped in the reception signal received by the receiver, and
demodulating one of the first data and the second data on the basis of a determination result obtained at the determining.
